(19) United States
(12) Patent Application Publication
(10) Pub. No.: US 2021/0112158 A1
(43) Pub. Date: Apr. 15, 2021

(54) COMMUNICATION PROCESSING SYSTEM, NETWORK SETTING METHOD, COMMUNICATION PROCESSING APPARATUS, COMMUNICATION PROCESSING METHOD, AND COMMUNICATION PROCESSING PROGRAM

(71) Applicant: NEC CORPORATION, Tokyo (JP)

(72) Inventor: Akihisa KURASHIMA, Tokyo (JP)

(73) Assignee: NEC CORPORATION, Tokyo (JP)

(21) Appl. No.: 16/497,598

(22) PCT Filed: Jan. 10, 2018
(86) PCT No.: PCT/JP2018/000361

§ 371 Date: Sep. 25, 2019

(30) Foreign Application Priority Data
Mar. 31, 2017 (JP) 2017-070004

(51) Int. Cl. H04M 3/02; H04M 7/00; H04M 3/38; H04L 29/06

(52) U.S. Cl. CPC H04M 3/02; H04L 65/403; H04M 3/38; H04M 7/0075

(57) ABSTRACT

The present invention is directed to a communication processing apparatus that makes various settings and changes concerning communication between communication terminals by a simple operation on the site using the communication terminal. The communication processing apparatus includes a first storage unit that stores, in association with each other, a call destination number in a telephone system and setting information to be set by a controller for a switch device that connects at least two communication terminals, and an instructor that instructs the controller to perform a setting of communication between the at least two communication terminals using the setting information corresponding to the call destination number acquired from the telephone system. The setting of communication by the controller includes a communication capability to connect the communication terminals, for example, a priority or a confidentiality of communication between the communication terminals.

This application is based upon and claims the benefit of priority from Japanese patent application No. 2017-070004, filed on Mar. 31, 2017, the disclosure of which is incorporated herein in its entirety by reference.

### TECHNICAL FIELD

The present invention relates to a communication processing system, a network setting method, a communication processing apparatus, a communication processing method, and a communication processing program.

### BACKGROUND ART

In the above technical field, patent literature 1 discloses a technique of extracting speech communication start and end information from a server (SIP server) of an IP telephone system, transmitting the information to an SDN controller, and performing QoS setting and release at the start and end timings of speech communication. That is, QoS setting and release by an SDN controller that copes with origination and extinction of a speech communication call in an IP telephone system are performed.

### CITATION LIST

### Non-Patent Literature

Non-patent literature 1: Michael F. Finneran, “UC and SDN: Application Controlling Networks,” UNIFIED COMMUNICATION STRATEGIES, Feb. 27, 2014, http://www.ucstrategies.com/unified-communications-expert-views/uc-and-sdn-applications-controlling-networks.aspx

### SUMMARY OF THE INVENTION

### Technical Problem

In the technique described in the above literature, however, it is necessary to preset a speech communication call to be controlled in an IP telephone system, and it is impossible to make various settings and changes concerning communication between communication terminals on the site using the communication terminal.

The present invention provides a technique of solving the above-described problem.

### Solution to Problem

One example aspect of the present invention provides a communication processing apparatus comprising:

a first storage unit that stores, in association with each other, a call destination number in a telephone system and setting information to be set by a controller for a switch device that connects at least two communication terminals; and an instructor that instructs the controller to perform a setting of communication between the at least two communication terminals using the setting information corresponding to the call destination number acquired from the telephone system.

Another example aspect of the present invention provides a communication processing method comprising:

acquiring setting information for a setting of communication between at least two communication terminals corresponding to a call destination number, with reference to a first storage unit that stores, in association with each other, the call destination number in a telephone system and the setting information to be set by a controller for the switch device that connects the at least two communication terminals; and instructing the controller to perform the setting of communication between the at least two communication terminals using the setting information corresponding to the call destination number acquired from the telephone system.

Still other example aspect of the present invention provides a communication processing program for causing a computer to execute a method, comprising:

acquiring setting information for a setting of communication between at least two communication terminals corresponding to a call destination number, with reference to a first storage unit that stores, in association with each other, the call destination number in a telephone system and the setting information to be set by a controller for the switch device that connects the at least two communication terminals; and instructing the controller to perform the setting of communication between the at least two communication terminals using the setting information corresponding to the call destination number acquired from the telephone system.

Still other example aspect of the present invention provides a communication processing system comprising:

at least two communication terminals;

a first storage unit that stores, in association with each other, a call destination number in a telephone system and setting information to be set by a controller for a switch device that connects said at least two communication terminals; and

a setter that performs a setting of communication between said at least two communication terminals using the setting information corresponding to the call destination number acquired from the telephone system in the controller and the switch device.

Still other example aspect of the present invention provides a network setting method comprising:

acquiring setting information for a setting of communication between at least two communication terminals corresponding to a call destination number, with reference to a first storage unit that stores, in association with each other, the call destination number in the telephone system and the setting information to be set by a controller for a switch device that connects the at least two communication terminals; and

performing the setting of communication between the at least two communication terminals corresponding to the call destination number acquired from the telephone system in the controller and the switch device.

### Advantageous Effects of Invention

According to the present invention, it is possible to make various settings and changes concerning communication between communication terminals by a simple operation on the site using the communication terminal.

### BRIEF DESCRIPTION OF DRAWINGS

FIG. 1 is block diagram showing the arrangement of a communication processing apparatus according to the first example embodiment of the present invention;

FIG. 2 is a view showing an overview of a communication processing system including a communication processing apparatus according to the second example embodiment of the present invention;

FIG. 3 is a block diagram showing the arrangement of the communication processing system including the communication processing apparatus according to the second example embodiment of the present invention;

FIG. 4 is a sequence chart showing the operation procedure of the communication processing system including the communication processing apparatus according to the second example embodiment of the present invention;

FIG. 5 is a block diagram showing the functional arrangement of the communication processing apparatus according to the second example embodiment of the present invention;

FIG. 6A is a table showing the structure of a communication connection specifying table according to the second example embodiment of the present invention;

FIG. 6B is a table showing the structure of a priority setting table according to the second example embodiment of the present invention;

FIG. 7 is a block diagram showing the hardware arrangement of the communication processing apparatus according to the second example embodiment of the present invention;

FIG. 8 is a flowchart illustrating the processing procedure of the communication processing apparatus according to the second example embodiment of the present invention;

FIG. 9 is a table showing the structure of a confidentiality setting table according to the third example embodiment of the present invention;

FIG. 10 is a table showing the structure of a communication connection specifying table according to the fourth example embodiment of the present invention;

FIG. 11A is a sequence chart showing an operation procedure of a communication processing system including a communication processing apparatus according to the fifth example embodiment of the present invention;

FIG. 11B is a sequence chart showing another operation procedure of the communication processing system including the communication processing apparatus according to the fifth example embodiment of the present invention;

FIG. 12 is a block diagram showing the functional arrangement of the communication processing apparatus according to the fifth example embodiment of the present invention;

FIG. 13 is a table showing the structure of a communication connection specifying table according to the fifth example embodiment of the present invention;

FIG. 14 is a block diagram showing the arrangement of a communication processing system including a communication processing apparatus according to the sixth example embodiment of the present invention;

FIG. 15 is a sequence chart showing the operation procedure of the communication processing system including the communication processing apparatus according to the sixth example embodiment of the present invention;

FIG. 16 is a table showing the structure of a communication connection specifying table according to the sixth example embodiment of the present invention;

FIG. 17A is a block diagram showing the arrangement of a communication processing system including a communication processing apparatus according to the seventh example embodiment of the present invention;

FIG. 17B is a block diagram showing the functional arrangement of a person recognition apparatus according to the seventh example embodiment of the present invention;

FIG. 18 is a table showing the structure of a call destination number table according to the seventh example embodiment of the present invention;

FIG. 19 is a view showing an overview of a communication processing system including a communication processing apparatus according to the eighth example embodiment of the present invention;

FIG. 20 is a block diagram showing the arrangement of the communication processing system including the communication processing apparatus according to the eighth example embodiment of the present invention;

FIG. 21 is a block diagram showing the functional arrangement of the communication processing apparatus according to the eighth example embodiment of the present invention;

FIG. 22 is a table showing the structure of a logical network setting table according to the eighth example embodiment of the present invention; and

FIG. 23 is a flowchart illustrating the processing procedure of the communication processing apparatus according to the eighth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

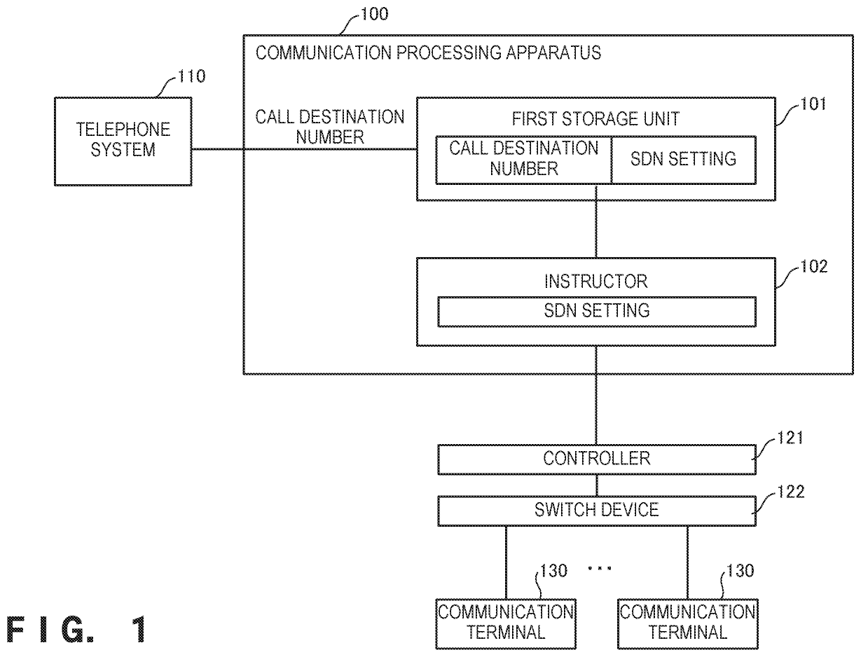

A communication processing apparatus 100 according to the first example embodiment of the present invention will be described with reference to FIG. 1. The communication processing apparatus 100 is an apparatus that instructs connection between communication terminals.

As shown in FIG. 1, the communication processing apparatus 100 includes a first storage unit 101 and an instructor 102. The first storage unit 101 stores, in association with each other, a call destination number in a telephone system 110 and a setting by a controller 121 for a switch device 122 that connects at least two communication terminals 130. The instructor 102 instructs the controller 121 to perform a setting between the at least two communication terminals 130 corresponding to an acquired call destination number.

According to this example embodiment, since a setting for the controller is instructed using the telephone system on the site, it is possible to make various settings and changes concerning communication between the communication terminals by a simple operation on the site using the communication terminal.

### Second Example Embodiment

A communication processing apparatus according to the second example embodiment of the present invention will be described next. The communication processing apparatus according to this example embodiment instructs an SDN controller to perform a setting in an SDN (Software-Defined Networking) corresponding to a call destination number from a telephone system on the site. The setting in the SDN includes the priority of communication as communication capability to connect communication terminals. The priority includes a communication capacity, a communication speed, and communication quality. In this example embodiment, the setting in the SDN is instructed after connection between the communication terminals, and the setting for the SDN is changed.

The call destination number in the telephone system is acquired from a telephone exchange or a virtual telephone that terminates a call. In addition, a call source number from a telephone in the telephone system and a communication terminal connected via the SDN are stored in association with each other, and a communication terminal for which a setting is to be performed is designated in accordance with the acquired call source number. The telephone as the device having the call source number is notified of whether the setting in the SDN has succeeded or not. Then, if an end of connection between the communication terminals is determined, the setting in the SDN is restored to the original one.

<<Communication Processing System>>

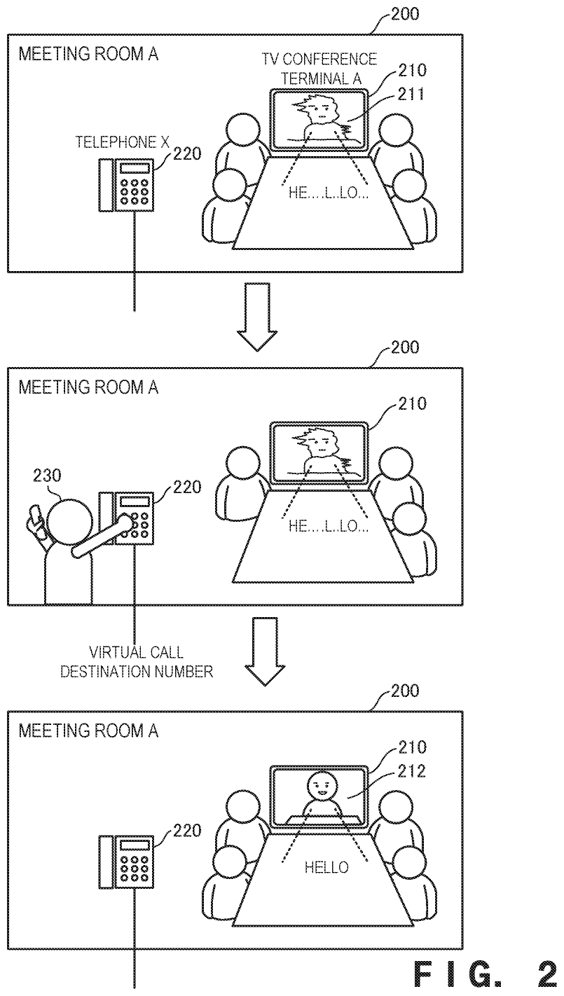

A communication processing system including a communication processing apparatus according to this example embodiment will be described with reference to FIGS. 2 to 4.

(Overview)

FIG. 2 is a view showing an overview of the communication processing system including the communication processing apparatus according to this example embodiment.

Referring to an upper view of FIG. 2, in a meeting room A 200, a television conference (to be referred to as TV conference hereinafter) terminal A 210 starts a TV conference with another meeting room at a different location. However, the image quality of a screen 211 of the TV conference terminal A 210 is poor, voice from the other meeting room tends to be interrupted.

Referring to a middle view of FIG. 2, a participant 230 makes a call to a predetermined destination number from a telephone X 220 to improve the communication quality between the TV conference terminals. The predetermined destination number is a virtual call destination number to a virtual telephone.

Referring to a lower view of FIG. 2, an instruction to increase the priority by the communication processing apparatus of this example embodiment improves the communication quality between the TV conference terminals, improves the image quality of a screen 212 of the TV conference terminal A 210, and obtain satisfactory voice from the other meeting room.

Such image quality and voice quality are implemented by instructing, from the communication processing apparatus of this example embodiment, the SDN controller to improve the communication quality between the TV conference terminals.

(Arrangement)

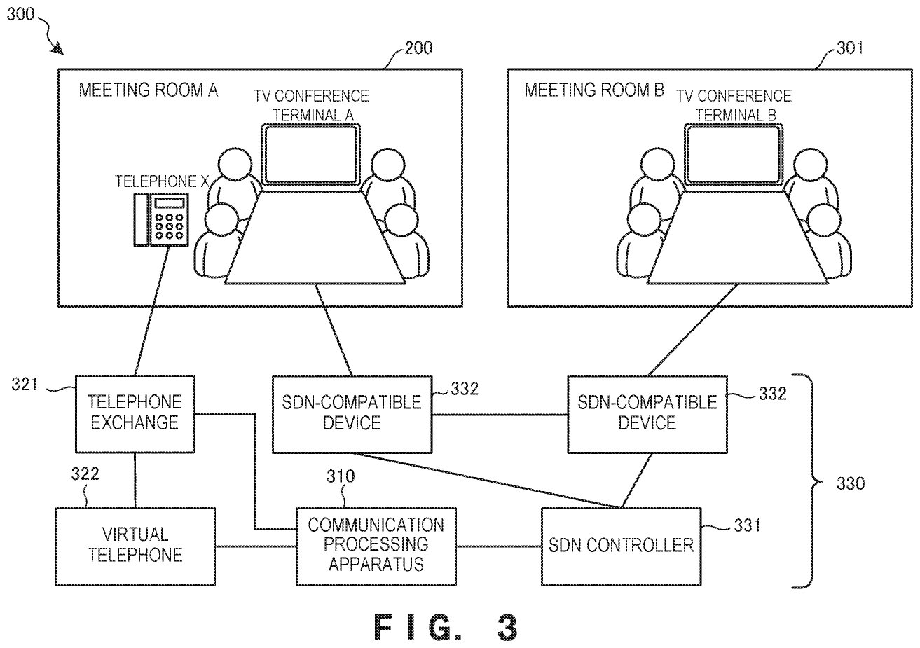

FIG. 3 is a block diagram showing the arrangement of a communication processing system 300 including a communication processing apparatus 310 according to this example embodiment. The communication processing system 300 indicates a TV conference held by the meeting room A 200 in which TV conference terminal A and telephone X are installed and a meeting room B 301 in which TV conference terminal B is installed.

The communication processing system 300 includes the communication processing apparatus 310 of this example embodiment, a telephone exchange 321 connected to telephone X, and a virtual telephone 322 virtually connected to the telephone exchange 321. Furthermore, the communication processing system 300 includes an SDN 330 including an SDN controller 331 that is controlled by the communication processing apparatus 310 of this example embodiment and an SDN-compatible device (for example, an SDN switch) 332 connected to TV conference terminal A and TV conference terminal B. Note that the virtual telephone 322 has a function of terminating a call to a predetermined call destination number by software inside or outside the telephone exchange 321, and notifying the communication processing apparatus 310 of call termination information including the call destination number. The SDN controller 331 will also be simply referred to as the “controller” hereinafter, and the SDN-compatible device (for example, the SDN switch) 332 will also be simply referred to as the “switch device” hereinafter.

(Operation Sequence)

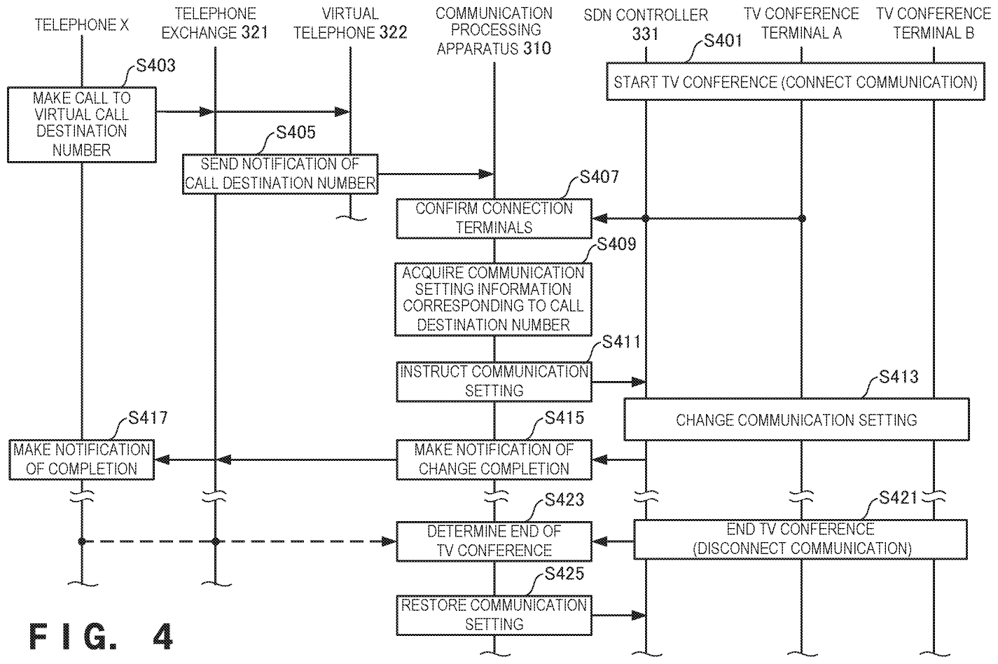

FIG. 4 is a sequence chart showing the operation procedure of the communication processing system 300 including the communication processing apparatus 310 according to this example embodiment.

In step S401, TV conference terminal A and TV conference terminal B are communicably connected in accordance with control of the SDN controller 331 to start a TV conference.

In step S403, a call is made from telephone X installed in meeting room A to a virtual call destination number. Upon receiving the call, the telephone exchange 321 or the virtual telephone 322 notifies, in step S405, the communication processing apparatus 310 of at least one of a call destination number or a call source number.

In step S407, the communication processing apparatus 310 confirms connection between TV conference terminal A and TV conference terminal B as TV conference terminals connected by the TV conference. Note that connection between the TV conference terminals participating in the TV conference can be confirmed based on the acquired call destination number or call source number with reference to a table held in advance in the communication processing apparatus 310. If there is TV conference terminal A in meeting room A in which telephone X is arranged, the SDN controller 331, or a TV conference apparatus (not shown) that manages the TV conference, the communication processing apparatus 310 may acquires the call destination number from the TV conference apparatus based on the acquired call source number. In step S409, the communication processing apparatus 310 acquires communication setting information corresponding to the call destination number. In step S411, the communication processing apparatus 310 instructs the SDN controller 331 to perform a communication setting in accordance with the acquired communication setting information. In step S413, the SDN controller 331 changes a connection setting between TV conference terminal A and TV conference terminal B. In this example, the communication capacity, communication speed, communication quality, and the like are changed to increase the priority of communication connection between TV conference terminal A and TV conference terminal B.

Upon receiving a notification of the completion of the setting change from the SDN controller 331, the communication processing apparatus 310 notifies, in step S415, telephone X of the completion of the setting change. In step S417, telephone X notifies TV conference participants of the completion of the setting change. Note that the destination of the notification of the completion of the setting change is not limited to telephone X, and may be mobile terminals carried by TV conference participants. In this case, the communication processing apparatus 310 is notified in advance of mobile terminal IDs. The completion notification is not a compulsory procedure but an optional operation, and may thus be omitted. The same applies to the following example embodiments.

If the TV conference ends to disconnect communication in step S421, the communication processing apparatus 310 determines, in step S423, the end of the TV conference, and performs, in step S425, processing of restoring the changed communication setting to the original one. Note that as indicated by a broken arrow in FIG. 4, the communication processing apparatus 310 may be notified of the end of the TV conference by making a call from telephone X to a virtual call destination number corresponding to the end of the TV conference. Note that recognition of the end of the TV conference by the communication processing apparatus 310 includes, for example, a method of making a notification from the TV conference terminal, a method of making a call to the call destination number to instruct the end of the TV conference, a method of making a notification of disconnection of communication corresponding to the TV conference from the SDN controller 331, or a method of making a notification from another apparatus that manages the TV conference if there is the other apparatus. Furthermore, a procedure of confirming the end of the TV conference from the communication processing apparatus 310 may be possible.

<<Functional Arrangement of Communication Processing Apparatus>>

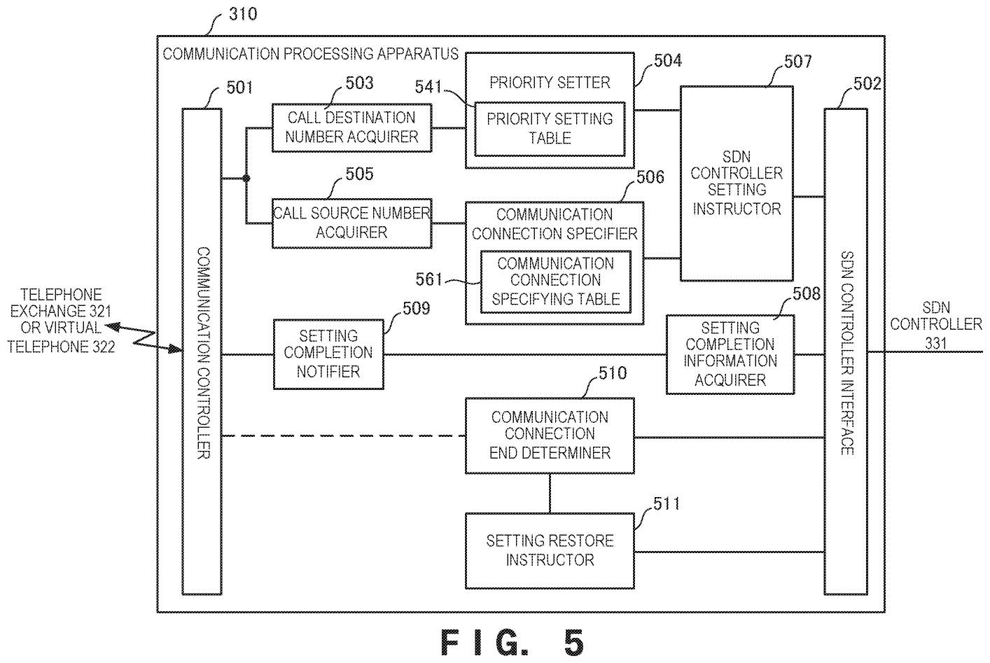

FIG. 5 is a block diagram showing the functional arrangement of the communication processing apparatus 310 according to this example embodiment.

The communication processing apparatus 310 includes a communication controller 501, an SDN controller interface 502, a call destination number acquirer 503, a priority setter 504, a call source number acquirer 505, a communication connection specifier 506, and an SDN controller setting instructor 507. Furthermore, the communication processing apparatus 310 includes a setting completion information acquirer 508, a setting completion notifier 509, a communication connection end determiner 510, and a setting restore instructor 511.

The communication controller 501 controls communication with the telephone exchange 321 or the virtual telephone 322. The SDN controller interface 502 serves as an interface with the SDN controller 331 to output a control command to the SDN controller 331 and input status data from the SDN controller 331.

The call destination number acquirer 503 acquires a virtual call destination number from the telephone exchange 321 or the virtual telephone 322. The priority setter 504 includes a priority setting table 541, and converts the call destination number into a priority setting instruction using the priority setting table 541 and outputs it to the SDN controller setting instructor 507. The call source number acquirer 505 acquires, from the telephone exchange 321 or the virtual telephone 322, a call source number from which the call is made to the virtual call destination number. The communication connection specifier 506 includes a communication connection specifying table 561, and specifies communication connection from the call source number using the communication connection specifying table 561 and outputs it to the SDN controller setting instructor 507. Note that in FIG. 5, the communication processing apparatus 310 holds in advance the communication connection specifying table 561. However, if a TV conference apparatus that manages a TV conference is externally provided, the table need not be held, and it is only necessary to inquire the TV conference apparatus about communication connection by the call source number or the like. The SDN controller setting instructor 507 specifies an SDN port based on the communication connection specified by the communication connection specifier 506, and instructs, via the SDN controller interface 502, the SDN controller 331 of the priority by the priority setter 504.

The setting completion information acquirer 508 acquires setting completion information from the SDN controller 331 via the SDN controller interface 502. Then, the setting completion notifier 509 notifies, of setting completion, a telephone that has made a call via the telephone exchange 321. Furthermore, the communication connection end determiner 510 determines the end of the communication connection (the end of the TV conference) based on information from the SDN controller 331, the telephone exchange 321, or the virtual telephone 322. Then, the setting restore instructor 511 restores the setting change in the SDN controller 331 to the original setting.

(Communication Connection Specifying Table)

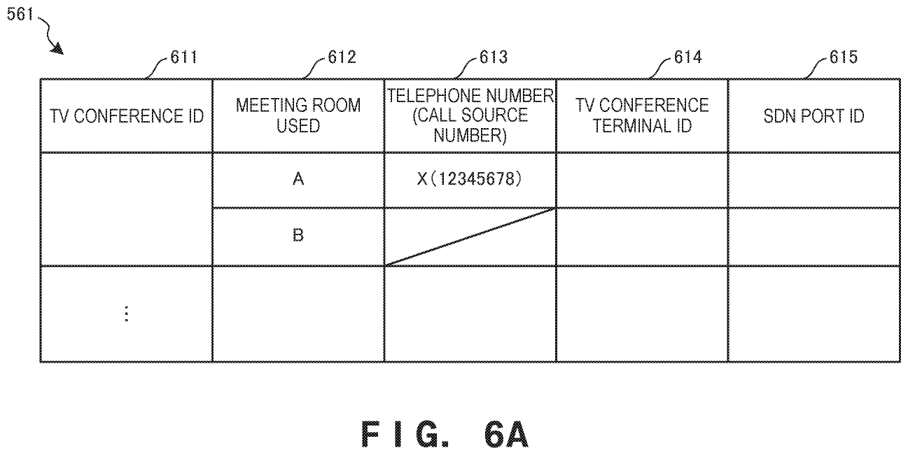

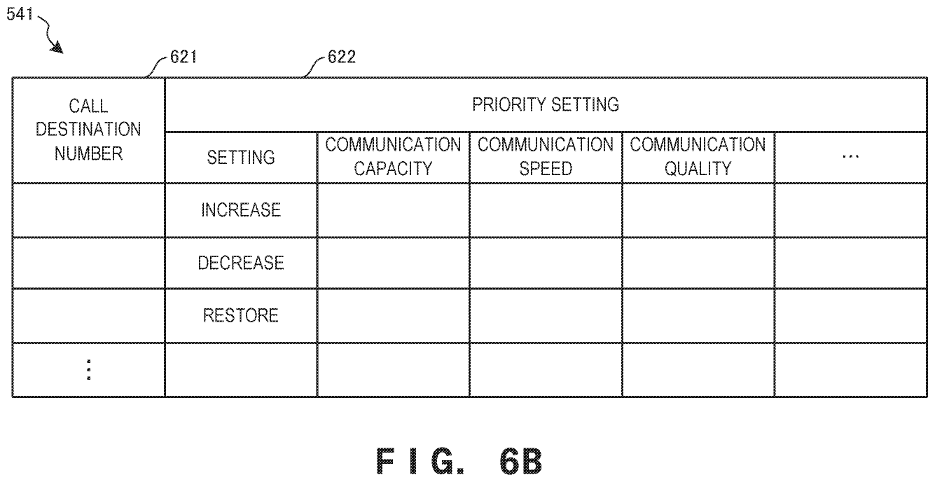

FIG. 6A is a table showing the structure of the communication connection specifying table 561 according to this example embodiment. The communication connection specifying table 561 is used by the communication connection specifier 506 to specify communication connection as a setting change target based on the call source number from which the call is made to the virtual destination number.

The communication connection specifying table 561 stores, in association with a TV conference ID 611, a meeting room 612 used, a telephone number (call source number) 613 of telephone X, a TV conference terminal ID 614 in meeting room A in which telephone X is installed, and an SDN port ID 615 connected to the TV conference terminal. For example, using the communication connection specifying table 561, a call from telephone X to the virtual call destination number is discriminated based on the call source number, TV conference terminal A and meeting room A in which telephone X is installed are specified, and TV conference terminal B connected to TV conference terminal A is specified.

(Priority Setting Table)

FIG. 6B is a table showing the structure of the priority setting table 541 according to this example embodiment. The priority setting table 541 is used by the priority setter 504 to convert the virtual call destination number into contents of the setting change, in this example, a priority setting change.

The priority setting table 541 stores a priority setting 622 in association with a virtual call destination number 621. The priority setting 622 includes setting contents such as a setting direction indicating whether to increase/decrease/restore the priority and the communication capacity/communication speed/communication quality.

<<Hardware Arrangement of Communication Processing Apparatus>>

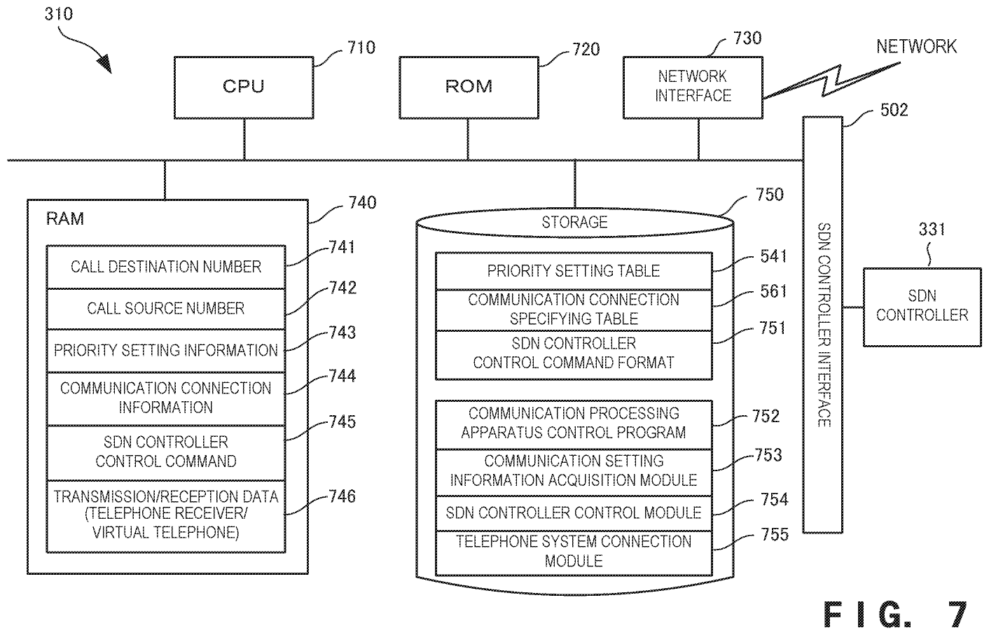

FIG. 7 is a block diagram showing the hardware arrangement of the communication processing apparatus 310 according to this example embodiment.

In FIG. 7, a CPU 710 is an arithmetic control processor, and implements the functional components shown in FIG. 5 by executing a program. The CPU 710 may include a plurality of processors to execute in parallel different programs, modules, tasks, or threads. A ROM 720 stores permanent data such as initial data and a program, and programs. A network interface 730 controls communication with the communication processing apparatus 310, the telephone exchange 321, the virtual telephone 322, and the like via a network.

A RAM 740 is a random access memory used as a temporary storage work area by the CPU 710. An area to store data necessary for implementation of the example embodiment is allocated to the RAM 740. A call destination number 741 is a call destination number to a virtual telephone acquired from the telephone exchange 321 or the virtual telephone 322. A call source number 742 is the call source number of a telephone that makes a call to the virtual call destination number 741. Priority setting information 743 is setting information of priority set by the priority setter 504. Communication connection information 744 is information of communication connection specified by the communication connection specifier 506. An SDN controller control command 745 is a control command to the SDN controller for setting priority based on the priority setting information 743 with respect to the communication connection specified by the communication connection information 744. Transmission/reception data 746 is data transmitted/received via a network interface 730 with the telephone exchange 321 or the virtual telephone 322.

A storage 750 stores a database, various parameters, or the following data or programs necessary for implementation of the example embodiment. The priority setting table 541 is a table, described with reference to FIG. 6B, for converting a call destination number into a priority setting. The communication connection specifying table 561 is a table, described with reference to FIG. 6A, for specifying communication connection as a setting target based on a call source number. An SDN controller control command format 751 is a format for generating an SDN controller control command for performing a setting in accordance with the priority setting information 743 based on the communication connection information 744.

The storage 750 stores the following programs. A communication processing apparatus control program 752 is a program for controlling the overall communication processing apparatus 310. A communication setting information acquisition module 753 is a module that acquires communication setting information based on a call destination number or a call source number. An SDN controller control module 754 is a module that controls the SDN controller in accordance with the acquired communication setting information. A telephone system connection module 755 is a module that acquires information by performing connection to the telephone exchange or the virtual telephone included in the telephone system.

The SDN controller interface 502 interfaces with the connected SDN controller 331.

Note that programs and data that are associated with the general-purpose functions of the communication processing apparatus 310 and other feasible functions are not shown in the RAM 740 or the storage 750 of FIG. 7.

<<Processing Procedure of Communication Processing Apparatus>>

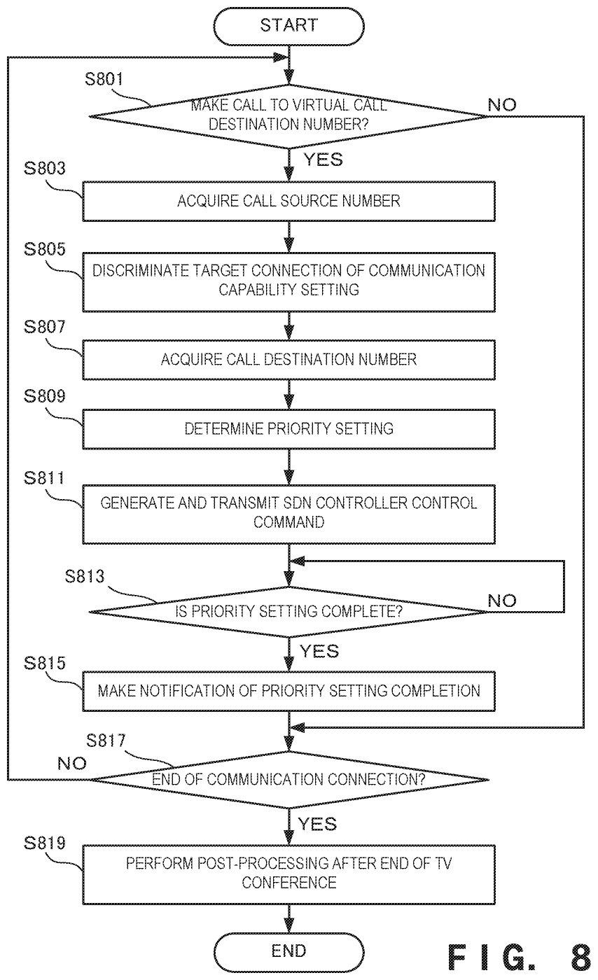

FIG. 8 is a flowchart illustrating the processing procedure of the communication processing apparatus 310 according to this example embodiment. This flowchart is executed by the CPU 710 of FIG. 7 using the RAM 740, thereby implementing the functional components shown in FIG. 5.

In step S801, based on virtual calling information received from the telephone exchange or the virtual telephone, the communication processing apparatus 310 determines whether a call is made to a virtual call destination number. If a call is made to a virtual call destination number, the communication processing apparatus 310 acquires a call source number from the virtual calling information in step S803. In step S805, based on the call source number, the communication processing apparatus 310 discriminates a communication capability setting, in this example embodiment, communication connection as a priority setting target.

In step S807, the communication processing apparatus 310 acquires the virtual call destination number from the virtual calling information. Then, in step S809, based on the call destination number, the communication processing apparatus 310 determines a communication capability setting, in this example embodiment, a priority setting.

In step S811, the communication processing apparatus 310 generates an SDN controller control command to change the priority of the communication connection as a setting target, and transmits it to the SDN controller. In step S813, the communication processing apparatus 310 waits for completion of the priority change by the SDN controller. Upon completion, the communication processing apparatus 310 notifies, in step S815, TV conference participants of the completion of the priority setting.

In step S817, the communication processing apparatus 310 determines the end of the communication connection, that is, the end of the TV conference. If the end of the TV conference is not determined, the communication processing apparatus 310 repeats the processes from step S801; otherwise, the communication processing apparatus 310 performs, in step S819, post-processing after the end of the TV conference, for example, processing of restoring the priority setting to the original one.

According to this example embodiment, since it is possible to instruct the SDN to set the priority of specific communication connection by making a call from a telephone in a meeting room, it is possible to make various settings and changes concerning communication between TV conference terminals by a simple operation in the meeting room that is the site using the TV conference terminal.

### Third Example Embodiment

A communication processing apparatus according to the third example embodiment of the present invention will be described next. The communication processing apparatus according to this example embodiment is different from the above-described second example embodiment in that a setting change to an SDN controller is confidentiality. The remaining components and operations are the same as those in the second example embodiment. Hence, the same reference numerals denote the same components and operations, and a detailed description thereof will be omitted.

(Confidentiality Setting Table)

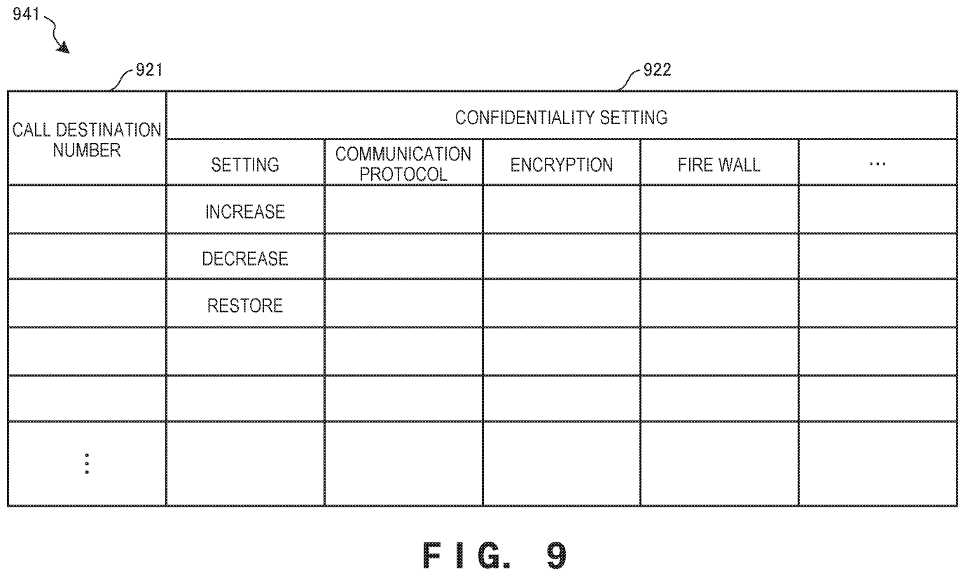

FIG. 9 is a table showing the structure of a confidentiality setting table 941 according to this example embodiment. The confidentiality setting table 941 is used to convert a virtual call destination number into contents of a setting change, in this example, a confidentiality setting change.

The confidentiality setting table 941 stores a confidentiality setting 922 in association with a virtual call destination number 921. The confidentiality setting 922 includes setting contents such as a setting direction indicating whether to increase/decrease/restore the confidentiality and the communication protocol/encryption/fire wall.

According to this example embodiment, since it is possible to instruct an SDN to set the confidentiality of specific communication connection by making a call from a telephone in a meeting room, it is possible to make various settings and changes concerning communication between TV conference terminals by a simple operation in the meeting room that is the site using the TV conference terminal.

### Fourth Example Embodiment

A communication processing apparatus according to the fourth example embodiment of the present invention will be described next. Communication processing according to this example embodiment is different from the above-described second and third example embodiments in that a communication setting change target is specified by call destination numbers to a plurality of virtual telephones. That is, a virtual telephone that terminates a call to a call destination number in a telephone system and a communication terminal connected via an SDN are stored in association with each other, and a communication terminal for which a setting corresponding to a virtual telephone that terminates a call is to be performed is designated. The remaining components and operations are the same as those in the second and third example embodiments. Hence, the same reference numerals denote the same components and operations, and a detailed description thereof will be omitted.

(Communication Connection Specifying Table)

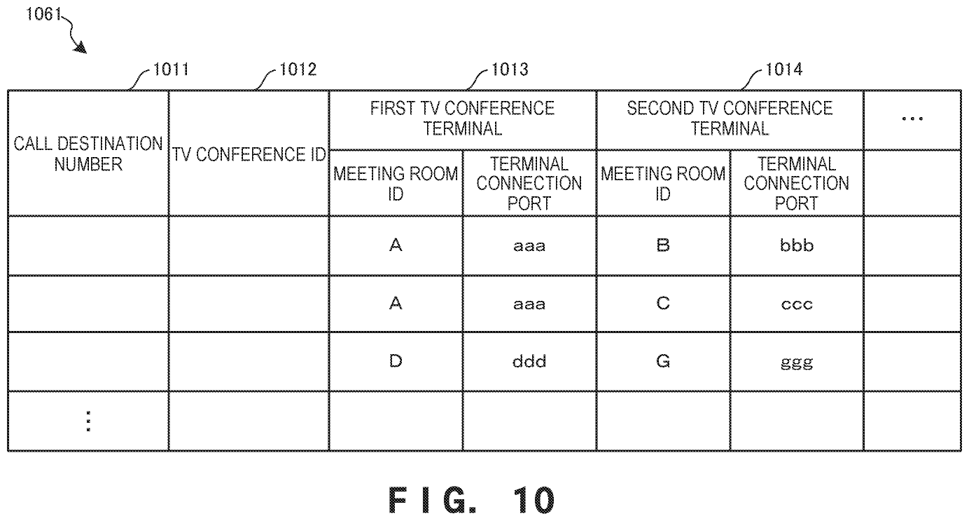

FIG. 10 is a table showing the structure of a communication connection specifying table 1061 according to this example embodiment. The communication connection specifying table 1061 replaces the communication connection specifying table 561 according to the second example embodiment, and is used to specify communication connection as a setting change target in the SDN in correspondence with a virtual call destination number to a virtual telephone. Note that a communication processing apparatus 310 is assumed to hold in advance the communication connection specifying table 1061. However, if a TV conference apparatus that manages a TV conference is externally provided, the table need not be held, and it is only necessary to inquire the TV conference apparatus about communication connection by the call destination number or the like.

The communication connection specifying table 1061 stores, in association with a call destination number 1011 to a virtual telephone, a TV conference ID 1012, and a first TV conference terminal 1013 and a second TV conference terminal 1014 both of which participate in the TV conference and are connected. Each of the first TV conference terminal 1013 and the second TV conference terminal 1014 includes a meeting room ID and a terminal connection port.

According to this example embodiment, a plurality of processes for specifying communication connection as a setting change target based on a call source number are performed by executing processing once based on a call destination number to a virtual telephone. Therefore, it is possible to make various settings and changes concerning communication between TV conference terminals by a simple operation in the meeting room that is the site using the TV conference terminal.

### Fifth Example Embodiment

A communication processing apparatus according to the fifth example embodiment of the present invention will be described next. The communication processing apparatus according to this example embodiment is different from the above-described second to fourth example embodiments in that a communication connection setting request is made before connection between communication terminals is performed upon the start of a TV conference, instead of performing communication connection setting change after the start of a TV conference. The remaining components and operations are the same as those in the second example embodiment. Hence, the same reference numerals denote the same components and operations, and a detailed description thereof will be omitted.

<<Operation Sequence of Communication Processing System>>

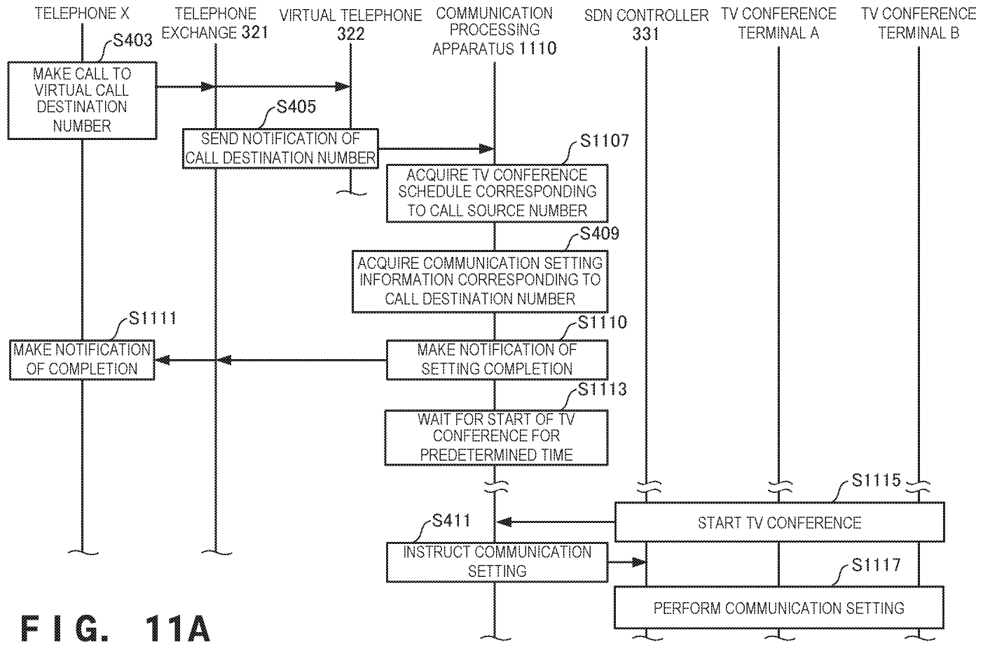

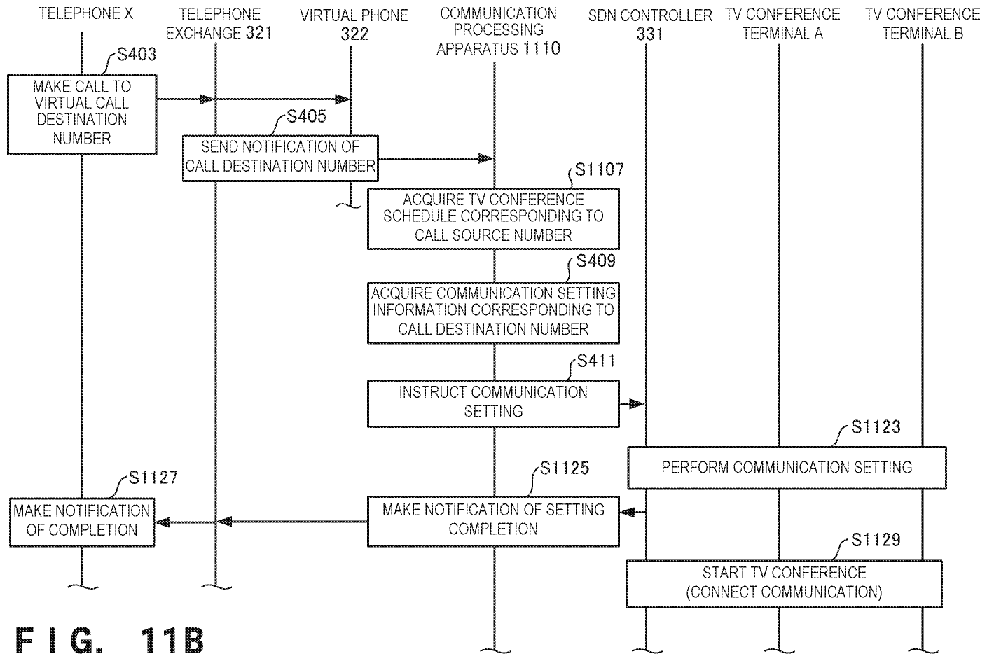

FIGS. 11A and 11B are sequence charts each showing an operation procedure of a communication processing system including a communication processing apparatus 1110 according to this example embodiment.

FIG. 11A is a sequence chart showing an operation procedure of holding a communication connection setting request before the start of a TV conference, and performing a setting at the start of the TV conference. Note that in FIG. 11A, the same step numbers as in FIG. 4 denote the same steps and a repetitive description thereof will be omitted.

In step S1107, the communication processing apparatus 1110 acquires a TV conference schedule corresponding to a call source number from which a call is made to a virtual call destination number. Note that the TV conference schedule may be held in the communication processing apparatus 1110 or acquired from an external TV conference schedule server. In step S1110, a communication processing apparatus 310 notifies telephone X of the completion of a setting. In step S1111, telephone X notifies TV conference participants of the completion of the setting. Note that the notification destination of the completion of the setting is not limited to telephone X, and may be mobile terminals carried by TV conference participants. In this case, the communication processing apparatus 310 is notified of mobile terminal IDs in advance. In step S1113, the communication processing apparatus 1110 holds communication setting information, and waits for the start of the TV conference for a predetermined time.

If TV conference start processing in step S1115 is performed within the predetermined time, the communication processing apparatus 1110 instructs, in step S411, based on the held communication setting information, an SDN controller 331 to perform a communication setting. In step S1117, the SDN controller 331 performs a connection setting between TV conference terminal A and TV conference terminal B. Note that recognition of the start of the TV conference by the communication processing apparatus 310 includes, for example, a method of making a notification from the TV conference terminal, a method of making a call from telephone X to a call destination number to instruct the end of the TV conference, a method of making a notification of disconnection of communication corresponding to the TV conference from the SDN controller 331, or a method of making a notification from another apparatus that manages the TV conference if there is the other apparatus. Furthermore, a procedure of confirming the start of the TV conference from the communication processing apparatus 310 may be possible.

FIG. 11B is a sequence chart showing an operation procedure in which a communication connection setting request before the start of a TV conference is set in the SDN controller and the SND controller performs corresponding connection at the start of the TV conference. Note that in FIG. 11B, the same step numbers as in FIGS. 4 and 11A denote the same steps and a repetitive description thereof will be omitted.

Referring to FIG. 11B, in step S411, the communication processing apparatus 1110 sets communication connection for the SDN controller 331 without waiting for the start of the TV conference. Upon receiving a notification of the completion of the setting from the SDN controller 331, the communication processing apparatus 1110 notifies, in step S1125, telephone X of the completion of the setting, and telephone X notifies, in step S1127, TV conference participants of the completion of the setting. Note that a notification of the completion of the setting may be made from mobile terminals carried by TV conference participants. Then, the SDN controller 331 performs set communication connection at the start of the TV conference in step S1129.

As described above, it is possible to set the priority or confidentiality of communication connection before the start of the TV conference by the operation procedure shown in FIG. 11A or 11B.

<<Functional Arrangement of Communication Processing Apparatus>>

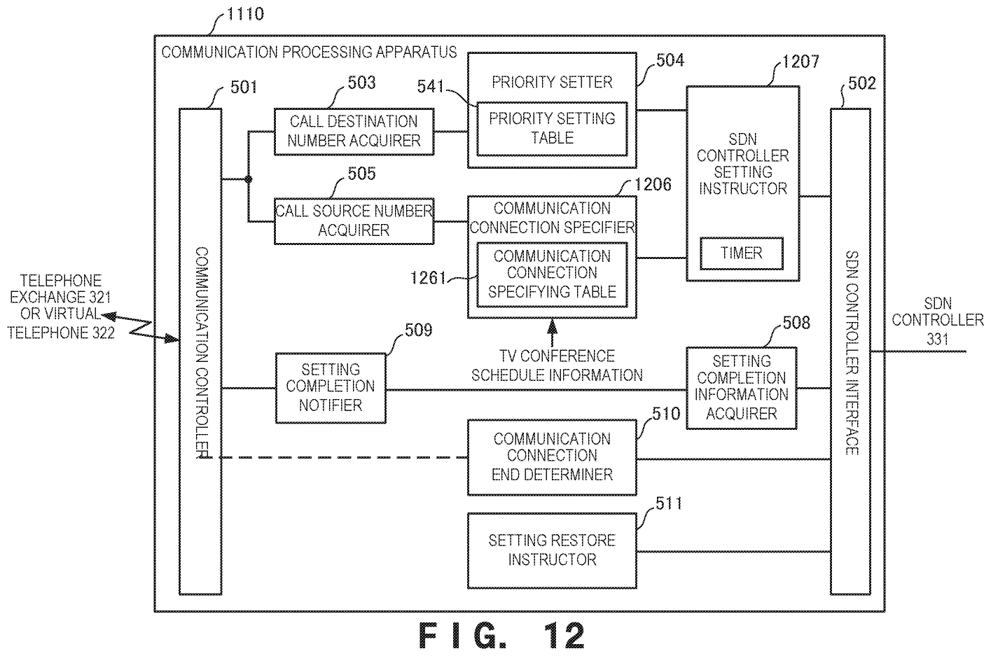

FIG. 12 is a block diagram showing the functional arrangement of the communication processing apparatus 1110 according to this example embodiment. Note that in FIG. 12, the same reference numerals as in FIG. 5 denote the same functional components and a repetitive description thereof will be omitted.

The communication processing apparatus 1110 includes a communication connection specifier 1206 that specifies communication connection as a setting target based on TV conference schedule information, and an SDN controller setting instructor 1207 that sets communication connection between TV conference terminals of a TV conference which has not started. The communication connection specifier 1206 includes a communication connection specifying table 1261 for specifying communication connection based on a scheduled TV conference. The communication connection specifying table 1261 is used especially in the operation procedure shown in FIG. 11B. Note that the communication processing apparatus 1110 is assumed to hold in advance the communication connection specifying table 1261. However, if a TV conference apparatus that manages a TV conference is externally provided, the table need not be held, and it is only necessary to inquire the TV conference apparatus about TV conference reservation information and communication connection by a call source number or the like. The SDN controller setting instructor 1207 includes a timer for a time limit for waiting for the start of a TV conference. Note that this timer is used especially in the operation procedure shown in FIG. 11A.

(Communication Connection Specifying Table)

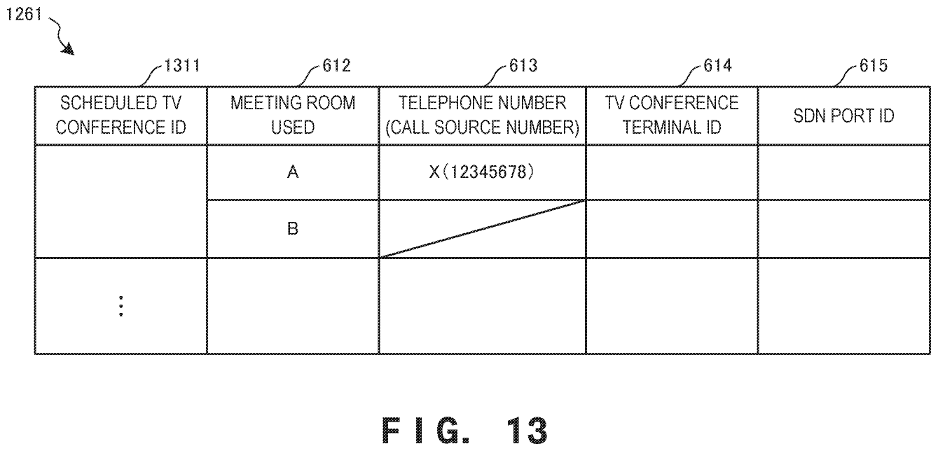

FIG. 13 is a table showing the structure of the communication connection specifying table 1261 according to this example embodiment. The communication connection specifying table 1261 is used to specify communication connection based on a scheduled TV conference acquired from a call source number from which a call is made to a virtual call destination number. Note that in FIG. 13, the same reference numerals as in FIG. 6A denote the same constituent elements and a repetitive description thereof will be omitted.

The communication connection specifying table 1261 stores, in association with a scheduled TV conference ID 1311, data for specifying communication connection.

According to this example embodiment, even before the start of a TV conference, it is possible to make various settings and changes concerning communication between TV conference terminals by a simple operation in a meeting room that is the site using the TV conference terminal.

### Sixth Example Embodiment

A communication processing apparatus according to the sixth example embodiment of the present invention will be described next. The communication processing apparatus according to this example embodiment is different from the above-described second to fifth example embodiments in that communication connection is set not when TV conference terminals are connected in one-to-one correspondence but when TV terminals at multiple points are connected. In this example, a case in which TV conference terminals at three points as multiple points are controlled by a multipoint TV conference apparatus will be described. The remaining components and operations are the same as those in the second to fifth example embodiments. Hence, the same reference numerals denote the same components and operations, and a detailed description thereof will be omitted.

<<Arrangement of Communication Processing System>>

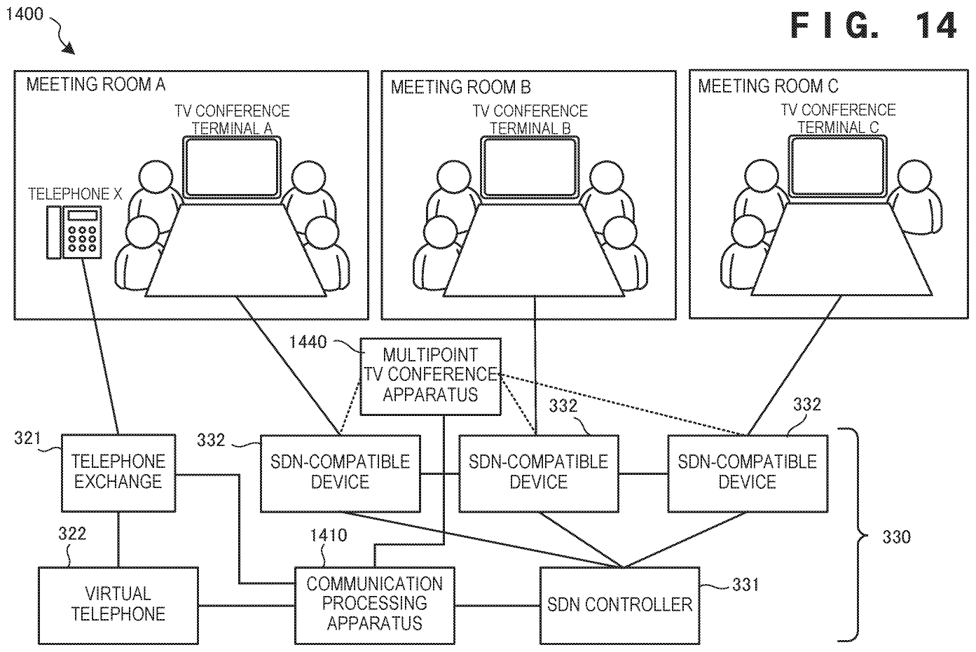

FIG. 14 is a block diagram showing the arrangement of a communication processing system 1400 including a communication processing apparatus 1410 according to this example embodiment. Note that in FIG. 14, the same reference numerals as in FIG. 3 denote the same constituent elements and a repetitive description thereof will be omitted.

Meeting room C in which TV conference terminal C is installed to participate in a multipoint TV conference is added to the communication processing system 1400. The communication processing system 1400 includes a multipoint TV conference apparatus 1440 that controls the multipoint TV conference by three TV conference terminals A to C at three points. Then, the communication processing apparatus 1410 of the communication processing system 1400 integrally sets or changes communication connection of the whole multipoint TV conference with reference to connection information of TV conference terminals A to C from the multipoint TV conference apparatus 1440.

<<Operation Sequence of Communication Processing System>>

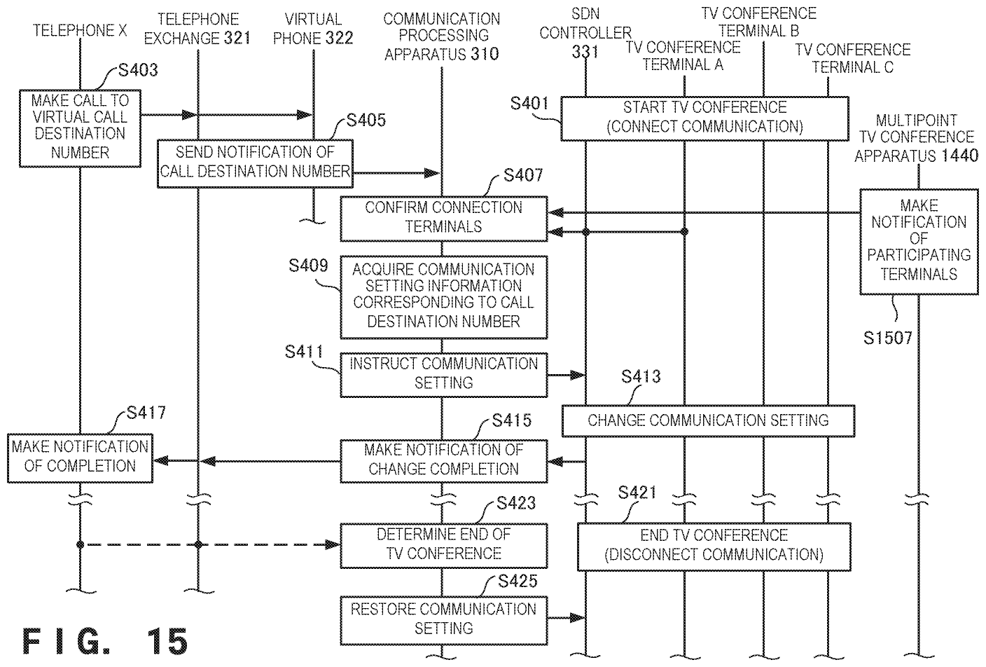

FIG. 15 is a sequence chart showing the operation procedure of the communication processing system 1400 including the communication processing apparatus 1410 according to this example embodiment. Note that in FIG. 15, the same step numbers as in FIG. 4 denote the same steps and a repetitive description thereof will be omitted.

In confirmation of connection terminals in step S407, a communication processing apparatus 310 also refers to information of the TV conference participating terminals at multiple points, which is notified from the multipoint TV conference apparatus 1440 in step S1507. Then, the communication processing apparatus 310 instructs an SDN controller 331 to change settings between all the TV conference participating terminals at the multiple points in a communication setting instruction in step S411.

(Communication Connection Specifying Table)

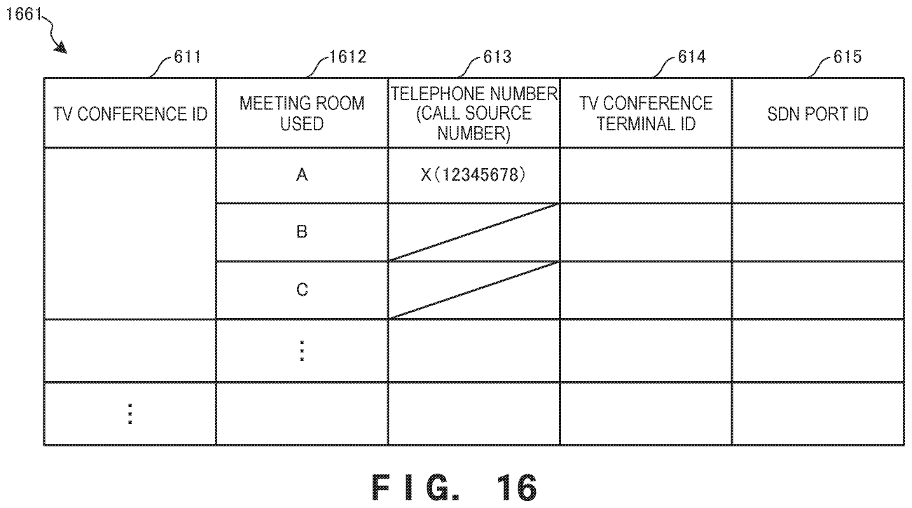

FIG. 16 is a table showing the structure of a communication connection specifying table 1661 according to this example embodiment. The communication connection specifying table 1661 replaces the communication connection specifying table 561 according to the second example embodiment, and is used to specify communication connection as a setting change target based on a call source number from which a call is made to a virtual call destination number in a multipoint TV conference. Note that in FIG. 16, the same reference numerals as in FIG. 6A denote the same constituent elements and a repetitive description thereof will be omitted. Note that as for the communication connection specifying table 1661 as well, if a TV conference apparatus that manages a TV conference is externally provided, the communication processing apparatus 310 need not hold the table, and it is only necessary to inquire the multipoint TV conference apparatus 1440 about communication connection by the call source number or the like.

The communication connection specifying table 1661 stores, in association with a TV conference ID 611, three or more meeting rooms 1612 to be used. The subsequent data are the same as in FIG. 6A except for the number of meeting rooms.

According to this example embodiment, even in a multipoint TV conference, it is possible to make various settings and changes concerning communication among three or more TV conference terminals by a simple operation in the meeting room that is the site using the TV conference terminal.

### Seventh Example Embodiment

A communication processing apparatus according to the seventh example embodiment of the present invention will be described next. The communication processing apparatus according to this example embodiment is the same as in the above-described second example embodiment except that a virtual call destination number is acquired from a device different from telephone X. That is, the device different from telephone X is a device having a function of determining a condition for making a call to a call destination number and, for example, sets communication connection between TV conference terminals based on recognition of a person captured by a camera. The remaining components and operations are the same as those in the second example embodiment. Hence, the same reference numerals denote the same components and operations, and a detailed description thereof will be omitted.

<<Arrangement of Communication Processing System>>

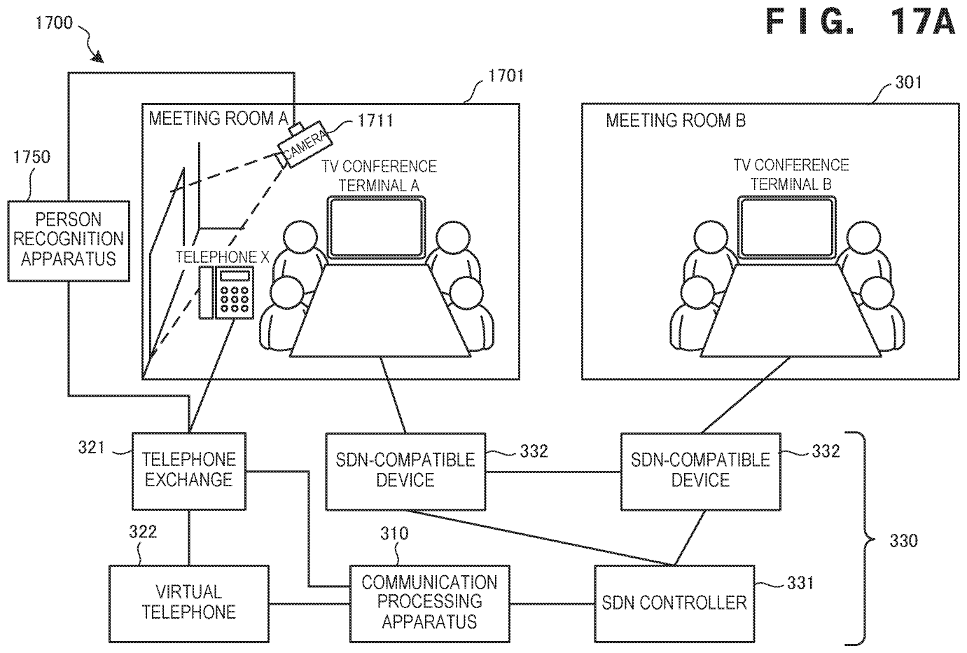

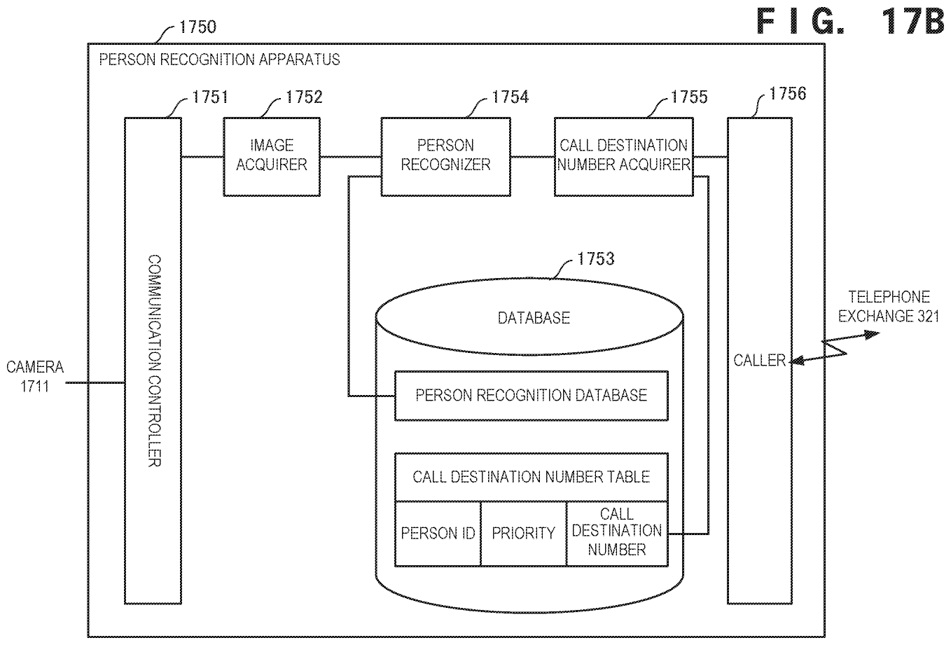

FIG. 17A is a block diagram showing the arrangement of a communication processing system 1700 including a communication processing apparatus 310 according to this example embodiment. Note that in FIG. 17A, the same reference numerals as in FIG. 3 denote the same constituent elements and a repetitive description thereof will be omitted.

In the communication processing system 1700, a meeting room 1701 is shown, in which a camera 1711 that captures a person who enters the room and a person recognition apparatus 1750 that makes a call to a virtual call destination number to set communication connection corresponding to a person specified by recognizing the captured person are provided.

<<Functional Arrangement of Person Recognition Apparatus>>

FIG. 17B is a block diagram showing the functional arrangement of the person recognition apparatus 1750 according to this example embodiment.

The person recognition apparatus 1750 includes a communication controller 1751, an image acquirer 1752 that acquires an image from the camera 1711, a database 1753 for person recognition and acquisition of a virtual call destination number, a person recognizer 1754, a call destination number acquirer 1755, and a caller 1756 that makes a call to a telephone exchange 321 by a virtual call destination number.

The database 1753 stores a person recognition database and a call destination number table. The call destination number table includes a person ID, priority, and a call destination number. The person recognizer 1754 recognizes a person captured by the camera 1711 with reference to the person recognition database. The call destination number acquirer 1755 acquires a call destination number for setting priority corresponding to a person with reference to the call destination number table.

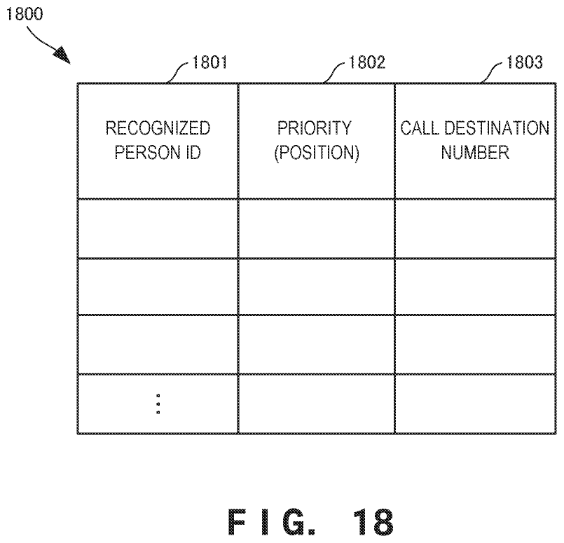

(Call Destination Number Table) FIG. 18 is a table showing the structure of a call destination number table 1800 according to this example embodiment. The call destination number table 1800 is used to generate a virtual call destination number corresponding to recognition of a person who enters a meeting room.

The call destination number table 1800 stores, in association with a recognized person ID 1801, priority 1802 of communication connection according to importance such as a position, and a virtual call destination number 1803 for setting the priority 1802 for an SDN controller 331.

According to this example embodiment, not only in a telephone installed in a meeting room but also in a device having a function of determining a condition for making a call to another call destination number, it is possible to readily make various settings and changes concerning communication between TV conference terminals in a meeting room that is the site using the TV conference terminal.

### Eighth Example Embodiment

A communication processing apparatus according to the eighth example embodiment of the present invention will be described next. The communication processing apparatus according to this example embodiment is different from the above-described second to seventh example embodiments in that an instruction is sent to an SDN controller to switch assignment of an information outlet to a logical network in correspondence with a virtual call destination number, instead of requesting the SDN controller to set communication capability or communication quality. The remaining components and operations are the same as those in the second to seventh example embodiments. Hence, the same reference numerals denote the same components and operations, and a detailed description thereof will be omitted.

<<Overview of Communication Processing System>>

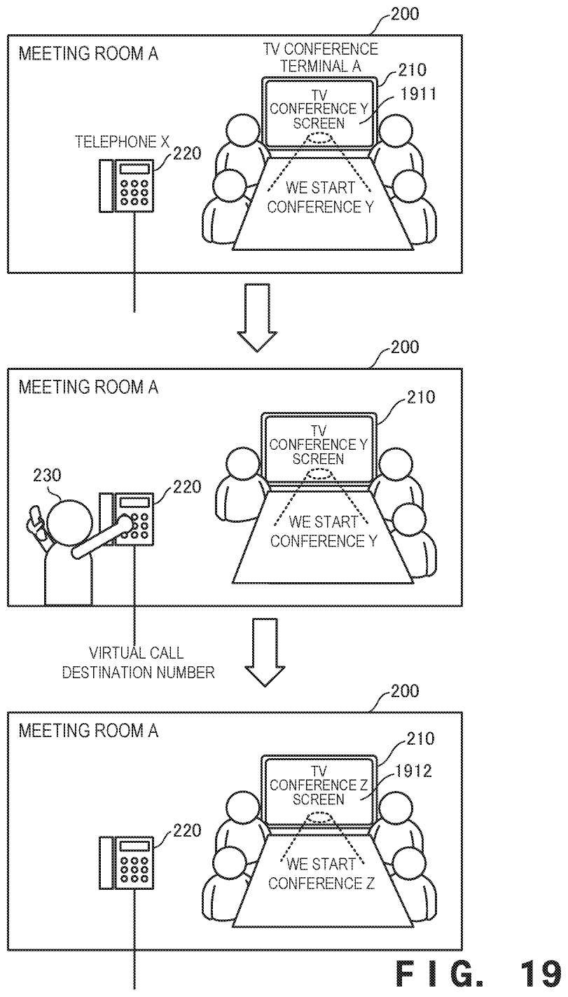

FIG. 19 is a view showing an overview of a communication processing system including a communication processing apparatus according to this example embodiment.

Referring to an upper view of FIG. 19, in a meeting room A 200, a TV conference terminal A 210 starts a TV conference with another meeting room. However, participation in TV conference Y is displayed on a screen 1911 of the TV conference terminal A 210 and a voice is also output.

Referring to a middle view of FIG. 19, a participant 230 makes a call from a telephone X 220 to a predetermined destination number to switch a logical network assigned to an information outlet that connects the TV conference terminal A 210. The predetermined destination number is a virtual call destination number to a virtual telephone.

Referring to a lower view of FIG. 19, the instruction to switch the logical network assigned to the information outlet by the communication processing apparatus according to this example embodiment displays participation in TV conference Z on a screen 1912 of the TV conference terminal A 210, and also outputs a voice.

Switching of the TV conference to participate is implemented by instructing, from the communication processing apparatus of this example embodiment, the SDN controller to switch the logical network assigned to the information outlet. Note that switching of the TV conference has been exemplified with reference to FIG. 19. However, if the priority, communication quality, or confidentiality of communication connection is different for each logical network, it can be switched.

However, this example embodiment is not limited to the above example, and it is possible to perform various switching operations by making a call to a virtual telephone by a virtual call destination number in accordance with a feature given to a logical network.

<<Arrangement of Communication Processing System>>

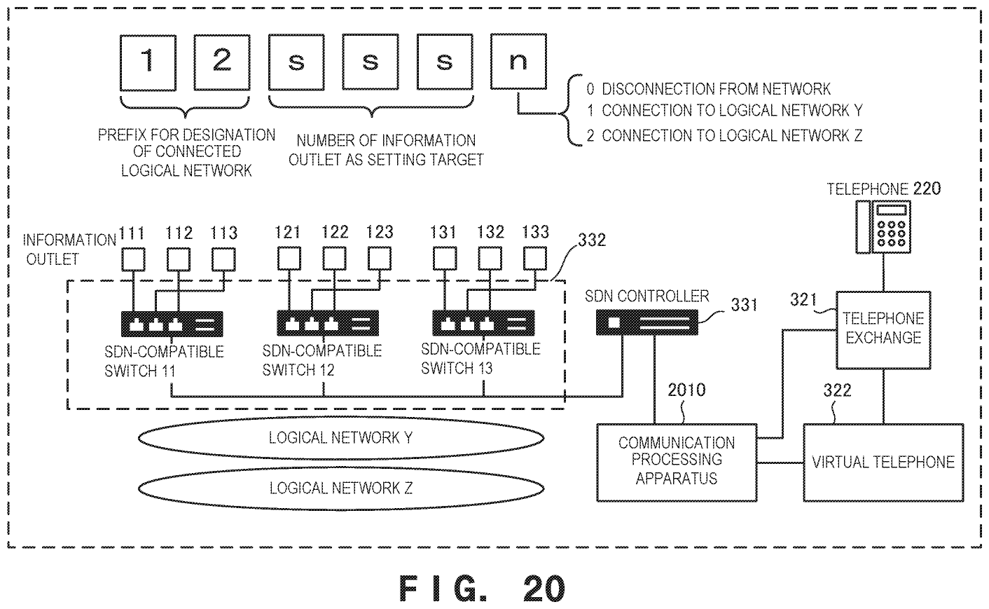

FIG. 20 is a block diagram showing the arrangement of a communication processing system including a communication processing apparatus 2010 according to this example embodiment. Note that in FIG. 20, the same reference numerals as in FIG. 3 denote the same constituent elements and a repetitive description thereof will be omitted.

Referring to FIG. 20, a logical network assigned to a port of an information outlet is switched by changing the setting of the information outlet connected to an SDN, that is, dialing a virtual call destination number from a telephone. The communication processing apparatus 2010 acquires, from a telephone exchange 321 or a virtual telephone 322, a virtual call destination number from a telephone, and switches a logical network assigned to the port of the information outlet in accordance with the virtual call destination number.

In the example shown in FIG. 20, in a 6-digit virtual call destination number, upper two digits “12” represent the switching instruction of the connected logical network, the next three digits “sss” represent the number of the information outlet as a setting target, and the lower one digit “n” represents switching contents of the logical network. In FIG. 20, as the switching contents of the logical network represented by the lower one digit “n”, “0” indicates disconnection from the network, “1” indicates connection to logical network Y, and “2” indicates connection to logical network Z. The present invention, however, is not limited to them.

<<Functional Arrangement of Communication Processing Apparatus>>

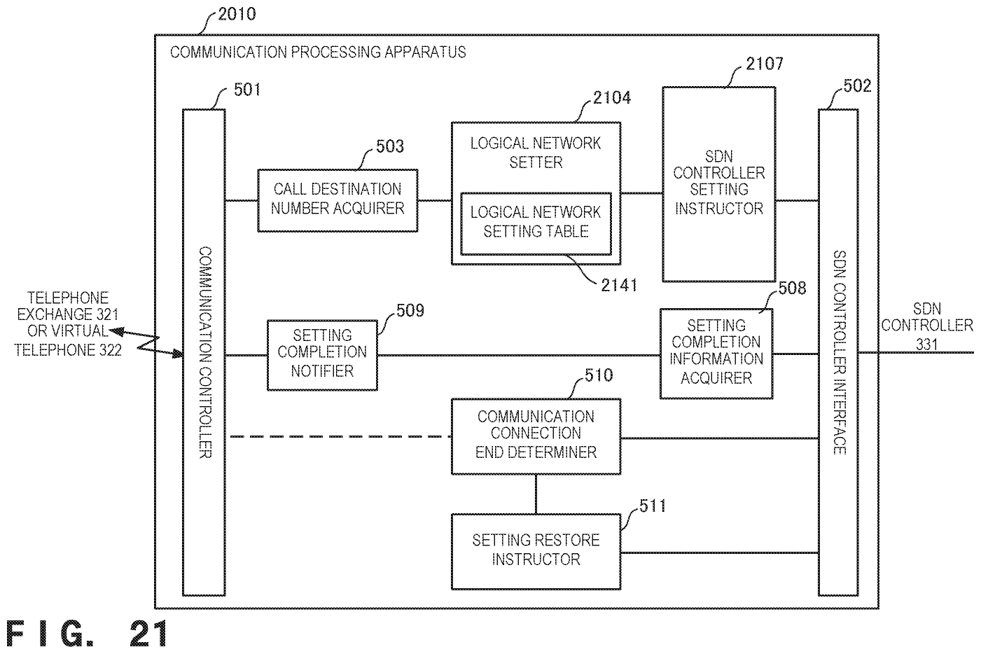

FIG. 21 is block diagram showing the functional arrangement of the communication processing apparatus 2010 according to this example embodiment. Note that in FIG. 21, the same reference numerals as in FIG. 5 denote the same functional components and a repetitive description thereof will be omitted.

The communication processing apparatus 2010 includes a logical network setter 2104 and an SDN controller setting instructor 2107. The logical network setter 2104 sets a logical network with reference to a logical network setting table 2141 based on a virtual call destination number acquired by a call destination number acquirer 503. The SDN controller setting instructor 2107 generates a control command of a setting instruction to the SDN controller to set a logical network.

(Logical Network Setting Table)

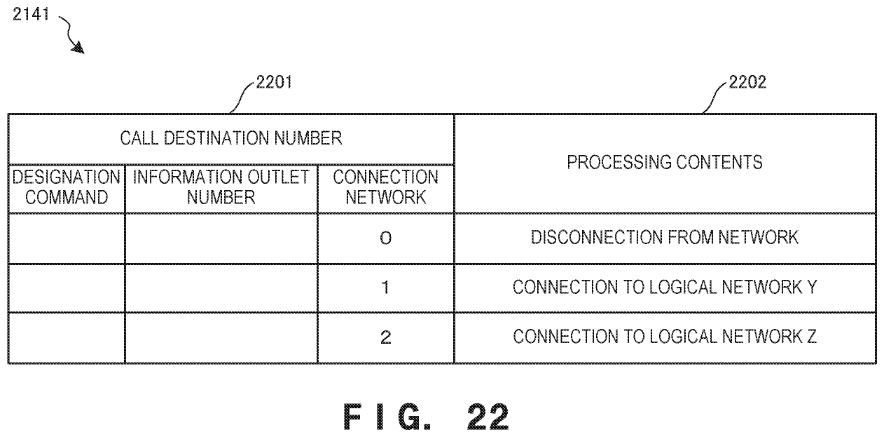

FIG. 22 is a table showing the structure of the logical network setting table 2141 according to this example embodiment. The logical network setting table 2141 is used by the logical network setter 2104 to set a logical network based on a virtual call destination number.

The logical network setting table 2141 stores processing contents 2202 in association with a 6-digit virtual call destination number 2201. Note that the 6-digit virtual call destination number 2201 includes designation command digits, information outlet number digits, and a connection network digit, as described with reference to FIG. 20.

<<Processing Procedure of Communication Processing Apparatus>>

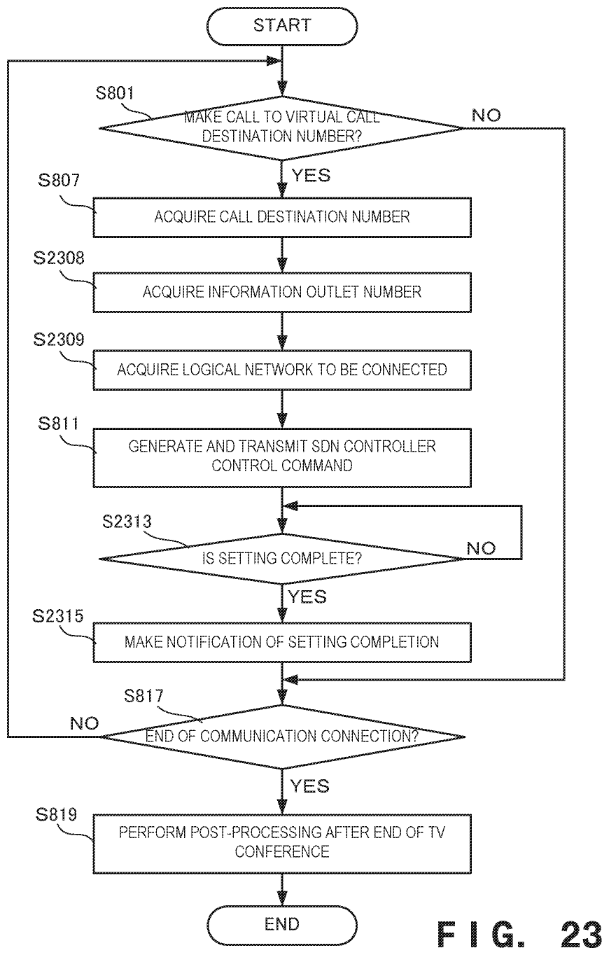

FIG. 23 is a flowchart illustrating the processing procedure of the communication processing apparatus 2010 according to this example embodiment. Note that in FIG. 23, the same step numbers as in FIG. 8 denote the same steps and a repetitive description thereof will be omitted.

In step S2308, the communication processing apparatus 2010 acquires an information outlet number from a virtual call destination number. In step S2309, the communication processing apparatus 2010 acquires a logical network to be assigned to the information outlet acquired from the virtual call destination number. In step S2313, the communication processing apparatus 2010 waits for completion of assignment of the logical network to the information outlet. Upon completion of assignment, the communication processing apparatus 2010 makes a notification of the completion of the assignment in step S2315. Note that as described above, the notification destination may be a calling telephone or a mobile terminal carried by the user.

According to this example embodiment, since a logical network assigned to an information outlet can be switched based on a virtual call destination number from a telephone system, it is possible to make various settings and changes concerning communication by a simple operation on the site using a communication terminal.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when a communication processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described example embodiments can also be described as in the following supplementary notes but are not limited to the followings.

(Supplementary Note 1)

There is provided a communication processing apparatus comprising:

a first storage unit that stores, in association with each other, a call destination number in a telephone system and setting information to be set by a controller for a switch device that connects at least two communication terminals; and

an instructor that instructs the controller to perform a setting of communication between the at least two communication terminals using the setting information corresponding to the call destination number acquired from the telephone system.

(Supplementary Note 2)

There is provided the communication processing apparatus according to supplementary note 1, wherein the setting of communication includes a setting of communication capability to connect the at least two communication terminals.

(Supplementary Note 3)

There is provided the communication processing apparatus according to supplementary note 2, wherein the communication capability includes at least one of priority and confidentiality of communication between the at least two communication terminals.

(Supplementary Note 4)

There is provided the communication processing apparatus according to supplementary note 3, wherein the priority includes at least one of a communication capacity, a communication speed and a communication quality.

(Supplementary Note 5)

There is provided the communication processing apparatus according to any one of supplementary notes 1 to 4, wherein the setting of communication includes switching of logical networks that connect the at least two communication terminals.

(Supplementary Note 6)

There is provided the communication processing apparatus according to supplementary note 5, wherein the switching of the logical networks is switching by assigning one of the logical networks to information outlets connected to the at least two communication terminals.

(Supplementary Note 7)

There is provided the communication processing apparatus according to any one of supplementary notes 1 to 6, wherein said instructor acquires the call destination number from one of a telephone exchange and a virtual telephone that terminates a call from the telephone system.

(Supplementary Note 8)

There is provided the communication processing apparatus according to any one of supplementary notes 1 to 7, further comprising:

a second storage unit that stores, in association with each other, a call source number in the telephone system and at least two communication terminals connected via the switch device; and

a first designator that designates, for the switch device, the at least two communication terminals corresponding to the call source number acquired from the telephone system, for which the setting of communication is to be performed.

(Supplementary Note 9)

There is provided the communication processing apparatus according to any one of supplementary notes 1 to 7, further comprising:

a third storage unit that stores, in association with each other, a virtual telephone that terminates a call from the telephone system to the call destination number in the telephone system and at least two communication terminals connected via the switch device; and

a second designator that designates, for the switch device, the at least two communication terminals corresponding to the virtual telephone that terminates the call from the user telephone, for which the setting of communication is to be performed.

(Supplementary Note 10)

There is provided the communication processing apparatus according to supplementary note 8 or 9, wherein a device having the call source number includes at least one of a telephone and a device having a function of determining a condition for making a call to the call destination number.

(Supplementary Note 11)

There is provided the communication processing apparatus according to supplementary note 10, further comprising a notifier that notifies the device having the call source number of whether or not the setting of communication instructed by said instructor has succeeded.

(Supplementary Note 12)

There is provided the communication processing apparatus according to any one of supplementary notes 1 to 11, further comprising a determiner that determines an end of connection between the at least two communication terminals.

(Supplementary Note 13)

There is provided the communication processing apparatus according to any one of supplementary notes 1 to 12, wherein the setting of communication is changed by a setting of communication for the controller instructed by said instructor after connection between the at least two communication terminals.

(Supplementary Note 14)

There is provided the communication processing apparatus according to any one of supplementary notes 1 to 13, wherein the setting of communication is performed by the controller based on an instruction of said instructor before connection between the at least two communication terminals.

(Supplementary Note 15)

There is provided the communication processing apparatus according to any one of supplementary notes 1 to 14, wherein the at least two communication terminals are terminals that participate in a television conference.

(Supplementary Note 16)

There is provided the communication processing apparatus according to supplementary note 15, wherein said instructor instructs the controller to perform the setting of communication with reference to connection information from a control unit that controls a television conference in which at least three communication terminals participate at different locations.

(Supplementary Note 17)

There is provided a communication processing method comprising:

acquiring setting information for a setting of communication between at least two communication terminals corresponding to a call destination number, with reference to a first storage unit that stores, in association with each other, the call destination number in a telephone system and the setting information to be set by a controller for the switch device that connects the at least two communication terminals; and

instructing the controller to perform the setting of communication between the at least two communication terminals using the setting information corresponding to the call destination number acquired from the telephone system.

(Supplementary Note 18)

There is provided a communication processing program for causing a computer to execute a method, comprising:

acquiring setting information for a setting of communication between at least two communication terminals corresponding to a call destination number, with reference to a first storage unit that stores, in association with each other, the call destination number in a telephone system and the setting information to be set by a controller for the switch device that connects the at least two communication terminals; and

instructing the controller to perform the setting of communication between the at least two communication terminals using the setting information corresponding to the call destination number acquired from the telephone system.

(Supplementary Note 19)

There is provided a communication processing system comprising:

at least two communication terminals;

a first storage unit that stores, in association with each other, a call destination number in a telephone system and setting information to be set by a controller for a switch device that connects said at least two communication terminals; and

a setter that performs a setting of communication between said at least two communication terminals using the setting information corresponding to the call destination number acquired from the telephone system in the controller and the switch device.

(Supplementary Note 20)

There is provided a network setting method comprising:

acquiring setting information for a setting of communication between at least two communication terminals corresponding to a call destination number, with reference to a first storage unit that stores, in association with each other, the call destination number in the telephone system and the setting information to be set by a controller for a switch device that connects the at least two communication terminals; and

performing the setting of communication between the at least two communication terminals corresponding to the call destination number acquired from the telephone system in the controller and the switch device.

1. A communication processing apparatus comprising:
a first storage unit that stores, in association with each other, a call destination number in a telephone system and setting information to be set by a controller for a switch device that connects at least two communication terminals; and
an instructor that instructs the controller to perform a setting of communication between the at least two communication terminals using the setting information corresponding to the call destination number acquired from the telephone system.

2. The communication processing apparatus according to claim 1, wherein the setting of communication includes a setting of communication capability to connect the at least two communication terminals.

3. The communication processing apparatus according to claim 2, wherein the communication capability includes a priority and a confidentiality of communication between the at least two communication terminals.

4. The communication processing apparatus according to claim 3, wherein the priority includes at least one of a communication capacity, a communication speed and a communication quality.

5. The communication processing apparatus according to claim 1, wherein the setting of communication includes switching of logical networks that connect the at least two communication terminals.

6. The communication processing apparatus according to claim 5, wherein the switching of the logical networks is switching by assigning one of the logical networks to information outlets connected to the at least two communication terminals.

7. The communication processing apparatus according to claim 1, wherein said instructor acquires the call destination number from one of a telephone exchange and a virtual telephone that terminates a call from the telephone system.

8. The communication processing apparatus according to claim 1, further comprising:
a second storage unit that stores, in association with each other, a call source number in the telephone system and at least two communication terminals connected via the switch device; and
a first designator that designates, for the switch device, the at least two communication terminals corresponding to the call source number acquired from the telephone system, for which the setting of communication is to be performed.

9. The communication processing apparatus according to claim 1, further comprising:
a third storage unit that stores, in association with each other, a virtual telephone that terminates a call from the telephone system to the call destination number in the telephone system and at least two communication terminals connected via the switch device; and
a second designator that designates, for the switch device, the at least two communication terminals corresponding to the virtual telephone that terminates the call from the user telephone, for which the setting of communication is to be performed.

10. The communication processing apparatus according to claim 8, wherein a device having the call source number includes at least one of a telephone and a device having a function of determining a condition for making a call to the call destination number.

11. The communication processing apparatus according to claim 10, further comprising a notifier that notifies the device having the call source number of whether or not the setting of communication instructed by said instructor has succeeded.

12. The communication processing apparatus according to claim 1, further comprising a determiner that determines an end of connection between the at least two communication terminals.

13. The communication processing apparatus according to claim 1, wherein the setting of communication is changed by a setting of communication for the controller instructed by said instructor after connection between the at least two communication terminals.

14. The communication processing apparatus according to claim 1, wherein the setting of communication is performed by the controller based on an instruction of said instructor before connection between the at least two communication terminals.

15. The communication processing apparatus according to claim 1, wherein the at least two communication terminals are terminals that participate in a television conference.

16. The communication processing apparatus according to claim 15, wherein said instructor instructs the controller to perform the setting of communication with reference to connection information from a control unit that controls a television conference in which at least three communication terminals participate at different locations.

17. (canceled)

18. A non-transitory computer-readable storage medium storing a communication processing program for causing a computer to execute a method, comprising:
acquiring setting information for a setting of communication between at least two communication terminals corresponding to a call destination number, with reference to a first storage unit that stores, in association with each other, the call destination number in a telephone system and the setting information to be set by a controller for the switch device that connects the at least two communication terminals; and
instructing the controller to perform the setting of communication between the at least two communication terminals using the setting information corresponding to the call destination number acquired from the telephone system.

19. (canceled)

20. A network setting method comprising:
at least two communication terminals;
acquiring setting information for a setting of communication between at least two communication terminals corresponding to a call destination number, with reference to a first storage unit that stores, in association with each other, the call destination number in the telephone system and the setting information to be set by a controller for a switch device that connects the at least two communication terminals; and
performing the setting of communication between the at least two communication terminals corresponding to the call destination number acquired from the telephone system in the controller and the switch device.

21. The communication processing apparatus according to claim 2, wherein the communication capability includes a confidentiality of communication between the at least two communication terminals.

22. The communication processing apparatus according to claim 8, further comprising:
a third storage unit that stores, in association with each other, a virtual telephone that terminates a call from the telephone system to the call destination number in the telephone system and at least two communication terminals connected via the switch device; and
a second designator that designates, for the switch device, the at least two communication terminals corresponding to the virtual telephone that terminates the call from the user telephone, for which the setting of communication is to be performed.
